(19) United States
(12) Patent Application Publication
(10) Pub. No.: US 2023/0112194 A1
(43) Pub. Date: Apr. 13, 2023

(54) Mobile Terminal And Control Method For Mobile Terminal

(71) Applicant: SEIKO EPSON CORPORATION, Tokyo (JP)

(72) Inventors: Yasuhiro TERASHIMA, Matsumoto (JP); Ryota HIRAKAWA, Shiojiri (JP)

(21) Appl. No.: 17/960,903

(22) Filed: Oct. 6, 2022

(30) Foreign Application Priority Data
Oct. 7, 2021 (JP) 2021-165347

(51) Int. Cl. G01S 19/47

(52) U.S. Cl. CPC G01S 19/47; G01C 21/165

(57) ABSTRACT

A mobile terminal includes a position information acquisition unit that receives radio waves transmitted from a positioning satellite and processes the radio waves to acquire position information, a movement speed detection unit that uses the Doppler effect of the radio waves transmitted from the positioning satellite to detect a movement speed, a communication unit that communicates with a first base station for the position information using wireless communication, and
a communication interval determination unit that determines a communication interval at which the communication unit performs communication based on the movement speed, in which the communication interval determination unit determines the communication interval such that the communication interval is longer when the movement speed is lower, and
the communication unit performs communication at the communication interval determined by the communication interval determination unit.

The present application is based on, and claims priority from JP Application Serial Number 2021-165347, filed Oct. 7, 2021, the disclosure of which is hereby incorporated by reference herein in its entirety.

### BACKGROUND

### 1. Technical Field

The present disclosure relates to a mobile terminal and a control method for the mobile terminal.

### 2. Related Art

A mobile terminal that receives satellite signals from a Global Positioning System (GPS) to recognize the movement route and the position when a sport accompanying with movement is performed has been utilized. JP-A-2008-128876 discloses a support navigator system that recognizes motions and positions of a marathon runner from a remote location or the like in real time.

To make this possible, the marathon runner needs to wear a mobile terminal. The mobile terminal receives radio waves transmitted from a positioning satellite, processes the radio waves, and acquires the position information. The mobile terminal transmits the position information to a base station for mobile phones. The position information transmitted from multiple marathon runners is transmitted to a server. The server combines map information with the position information to generate a composite map including points indicating where each of the marathon runners is located. Managers and supporters of the marathon game access the server using their mobile terminals to view the composite map.

According to JP-A-2008-128876, one type of sport is set to be performed. Mobile terminals transmit position information at constant communication intervals. There may be a sport in which a plurality of types of sport are continuously performed, such as triathlon. In swimming that is a sport performed at a slow movement speed, position information is transmitted over a shorter movement distance. In cycling that is a sport performed at a high movement speed, position information is transmitted over a longer movement distance. In this way, when types of sports played at different movement speeds are performed, the movement distance in which the position information is transmitted may be changed. Thus, a mobile terminal capable of transmitting position information at intervals of an appropriate distance even when the movement speed is changed has been desired.

### SUMMARY

A mobile terminal includes a position information acquisition unit that receives radio waves transmitted from a positioning satellite and processes the radio waves to acquire position information, a movement speed detection unit that uses the Doppler effect of the radio waves transmitted from the positioning satellite to detect a movement speed, a communication unit that communicates with a base station for the position information using wireless communication, and a control unit that determines a communication interval at which the communication unit performs communication based on the movement speed, in which the control unit determines the communication interval such that the communication interval is longer when the movement speed is lower, and the communication unit performs communication at the communication interval determined by the control unit.

A mobile terminal includes a position information acquisition unit that receives radio waves transmitted from a positioning satellite and processes the radio waves to acquire position information, a communication unit that communicates with a base station for the position information using wireless communication, an input unit that inputs a type of sport, a storage unit that stores a sport type-communication interval correspondence table indicating a correspondence relationship between the type of sport and a communication interval at which the communication unit performs communication, and a control unit that determines the communication interval based on the type of sport and the sport type-communication interval correspondence table, in which the communication unit performs communication at the communication interval determined by the control unit.

A control method for a mobile terminal including a position information acquisition unit that receives radio waves transmitted from a positioning satellite and processes the radio waves to acquire position information, a movement speed detection unit that uses the Doppler effect of the radio waves transmitted from the positioning satellite to detect a movement speed, a communication unit that communicates with a base station for the position information using wireless communication, and a control unit that determines a communication interval at which the communication unit performs communication, the control method including acquiring, by the position information acquisition unit, the position information at a predetermined interval, detecting, by the movement speed detection unit, the movement speed, determining, by the control unit, the communication interval such that the communication interval is longer when the movement speed is lower, and performing communication, by the communication unit, at the communication interval determined by the control unit.

### BRIEF DESCRIPTION OF THE DRAWINGS

FIG. 1 is a block diagram illustrating a configuration of a position display system according to a first embodiment.

FIG. 2 is an electrical control block diagram illustrating an electrical configuration of a mobile terminal.

FIG. 3 is a diagram for describing measurement data.

FIG. 4 is a flowchart of a communication procedure.

FIG. 5 is a diagram for describing a relationship between a movement speed and a communication interval.

FIG. 6 is a diagram for describing a relationship between an elapsed time and a movement distance.

FIG. 7 is a diagram for describing a movement speed determination table according to a second embodiment.

FIG. 8 is a diagram for describing a relationship between a movement speed and a communication interval.

FIG. 9 is a diagram for describing a relationship between an elapsed time and a movement distance.

FIG. 10 is a diagram for describing a sport type-communication interval correspondence table according to a third embodiment.

FIG. 11 is a diagram for describing sport type data according to a sixth embodiment.

FIG. 12 is a diagram for describing a relationship between an elapsed time and a movement distance according to a comparative example.

### DESCRIPTION OF EXEMPLARY EMBODIMENTS

### First Embodiment

In this embodiment, a characteristic example of a position display system using a mobile terminal, the mobile terminal, and a mobile terminal control method to control the mobile terminal will be described with reference to the drawings. The position display system is a system for displaying a position of a mobile terminal. A system for displaying a current position of a player in a game such as triathlon is a position display system. In this embodiment, an example of a triathlon game will be described. A triathlon game includes swimming, cycling, and running. Swimming is a swimming race, cycling is a bicycle race, and running is a marathon race. Further, a type of race is also referred to as a type of sport.

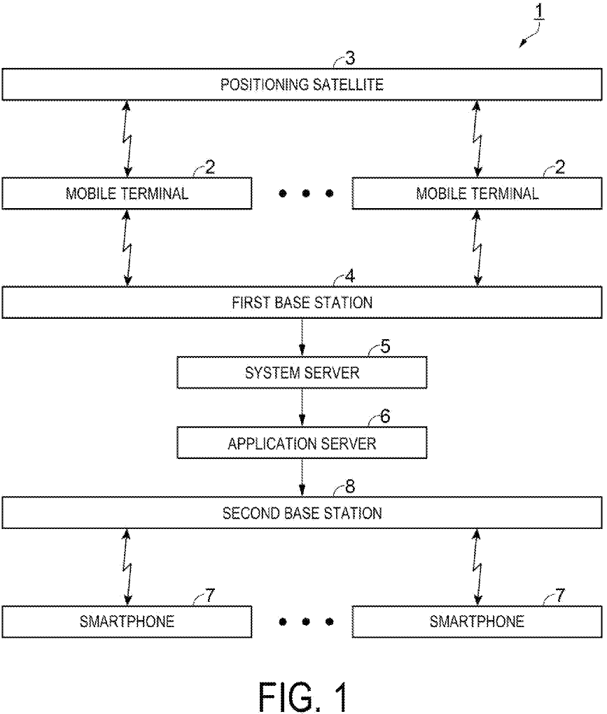

As illustrated in FIG. 1, a plurality of mobile terminals 2 are used in the position display system 1. Each of the mobile terminals 2 is worn by a player. The mobile terminal 2 receives radio waves transmitted from a positioning satellite 3. Although a reception interval thereof is not particularly limited, in this embodiment, for example, radio waves are received every one second. The mobile terminal 2 detects a current position and a movement speed using the radio waves.

The radio waves transmitted from the positioning satellite 3 include a Global Positioning System (GPS) satellite signal. An navigation message such as trajectory information (ephemeris or almanac) of a GPS satellite is transported with the GPS satellite signal overlapped. The mobile terminal 2 detects the current position from the navigation message.

The mobile terminal 2 uses the Doppler effect of the carrier wave of the radio waves transmitted from the positioning satellite 3 to detect the movement speed. The positioning satellite 3 emits very stable radio waves with a constant wavelength and a constant frequency. As the mobile terminal 2 moves, the frequency of the carrier wave received by the mobile terminal 2 continuously changes. Using the change in the frequency, the mobile terminal 2 calculates the movement speed of the mobile terminal 2. A horizontal speed accuracy of this detection method is approximately 0.1 km/h.

Each mobile terminal 2 transmits data including position information to a first base station 4 serving as a base station. Although communication between the mobile terminal 2 and the first base station 4 is not particularly limited, in this embodiment, for example, Long Term Evolution (LTE) communication is used. LTE communication is one of the cellular-based Low Power Wide Area (LPWA) standards provided by communication service providers. LTE communication utilizes some of frequencies of the first base station 4 installed in the nation to cover a wide area. The first base station 4 is also referred to as an LTE base station.

The data including the position information is transmitted from the first base station 4 to a system server 5. The data including the position information is transmitted to an application server 6 via the system server 5. The application server 6 combines map data and the position information to output composite map data. In the composite map data, a mark is placed at the position of a player on the map.

A manager of the games operates his or her smartphone 7 to access the application server 6. The smartphone 7 performs wireless communication with a second base station 8 to access the application server 6 via the second base station 8. The smartphone 7 acquires the composite map data and displays the composite map data on the display screen of the smartphone 7. The manager of the game views the composite map data to recognize the location of each player.

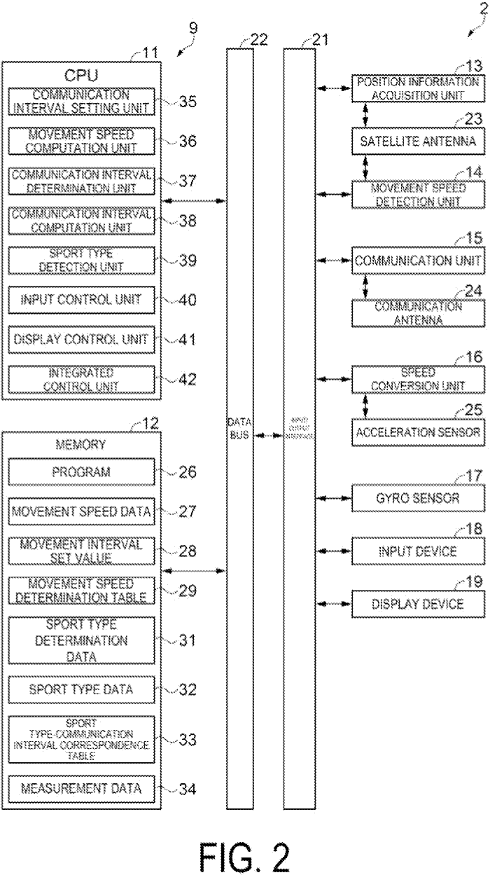

As illustrated in FIG. 2, the mobile terminal 2 includes a control unit 9 that performs arithmetic processing and control. The control unit 9 includes a central processing unit (CPU) 11 that performs various types of arithmetic processing as a processor, and a memory 12 that stores various types of information as a storage unit. A position information acquisition unit 13, a movement speed detection unit 14, a communication unit 15 as an input unit, a speed conversion unit 16 as a movement speed detection unit, a gyro sensor 17, and an input device 18 and a display device 19 serving as input units are electrically coupled to the CPU 11 of the control unit 9 via an input/output interface 21 and a data bus 22.

The position information acquisition unit 13 and the movement speed detection unit 14 include a satellite antenna 23 and are electrically coupled to the satellite antenna 23. The satellite antenna 23 is a part of the position information acquisition unit 13 and a part of the movement speed detection unit 14. The satellite antenna 23 receives radio waves transmitted from positioning satellite 3. The position information acquisition unit 13 processes the radio waves to acquire position information.

The movement speed detection unit 14 uses the Doppler effect of the radio waves transmitted from the positioning satellite 3 to detect the movement speed. The movement speed of the mobile terminal 2 detected by using the Doppler effect of the radio waves transmitted from the positioning satellite 3 is a second movement speed.

The communication unit 15 is electrically coupled to a communication antenna 24. The communication unit 15 communicates with the first base station 4 for the position information in wireless communication. In addition, the communication unit 15 communicates with the first base station 4 or the second base station 8 in wireless communication to receive an input of the type of the sport game.

The speed conversion unit 16 includes an acceleration sensor 25, and is electrically coupled to the acceleration sensor 25. The acceleration sensor 25 detects an acceleration of the mobile terminal 2. The speed conversion unit 16 converts an acceleration signal output by the acceleration sensor 25 into speed data indicating a speed change. The speed conversion unit 16 transmits the speed data indicating the speed change of the mobile terminal 2 to the CPU 11. The movement speed of the mobile terminal 2 detected by the acceleration sensor 25 is set as a first movement speed.

The gyro sensor 17 detects a change in an angular velocity of the mobile terminal 2. The gyro sensor 17 transmits angular velocity data indicating a change in an angular velocity of the mobile terminal 2 to the CPU 11.

The input device 18 includes a push button, a touch pad, a touch panel, and the like. A player operates the input device 18 to input the type of sport. The input device 18 is used for a setting of the mobile terminal 2 and input of information.

The display device 19 includes a liquid crystal panel, an organic EL panel, or the like. The display device 19 displays each type of information. In addition, the display device 19 prompts input of the type of sport.

The memory 12 is a concept including semiconductor memories such as a RAM and a ROM. The memory 12 stores a program 26 in which an operation control procedure of the mobile terminal 2 is described. In addition, the memory 12 stores movement speed data 27 indicating a movement speed of the mobile terminal 2 detected by the movement speed detection unit 14 and the speed conversion unit 16. In addition, the memory 12 stores a movement interval set value 28 corresponding to a communication interval. A communication interval is a time interval in which the communication unit 15 transmits position information to the first base station 4. The movement interval set value 28 is a set value for a distance interval at which the player moves. Further, a movement distance of the player is the same as the movement distance of the mobile terminal 2.

In addition, the memory 12 stores a movement speed determination table 29 indicating a relationship between a determined value of a movement speed and a communication interval. In addition, the memory 12 stores movement speeds of players and sport type determination data 31 indicating a relationship between an angular velocity detected by the gyro sensor 17 and the type of sport played by the player. In addition, the memory 12 stores sport type data 32 that is data of the type of sport played by the player in a game, or the like.

In addition, the memory 12 stores a sport type-communication interval correspondence table 33 showing a correspondence relationship between a type of sport and a communication interval at which the communication unit 15 communicates. The sport type-communication interval correspondence table 33 also stores data indicating a correspondence relationship between a type of sport and the upper limit value of a communication interval. In addition, the memory 12 stores measurement data 34 of a positioning time, a position, a split time, a distance, a pace, a running pitch, a stride during running, a stroke pitch during swimming, and the like. In addition, the memory 12 includes a work area for the CPU 11, a storage area that functions as a temporally file, and the like, and other various storage areas.

The CPU 11 performs processing of controlling the mobile terminal 2 to detect the current position and communicate with the first base station 4 in accordance with the program 26 stored in the memory 12. Specifically, the CPU 11 serving as a function realization unit has a communication interval setting unit 35. The communication interval setting unit 35 sets an initial value of a time interval at which the communication unit 15 communicates with the first base station 4. The initial value of the time interval may be input to the input device 18 by the player. When the application server 6 stores the initial value of the time interval, the communication unit 15 may access the application server 6 to set the initial value of the time interval.

In addition, the CPU 11 includes a movement speed computation unit 36. The movement speed computation unit 36 inputs the second movement speed from the movement speed detection unit 14. Furthermore, the movement speed computation unit 36 inputs the first movement speed from the speed conversion unit 16. When the movement speed detection unit 14 is not able to perform normal communication with the positioning satellite 3, the movement speed computation unit 36 employs the first movement speed. When the acceleration sensor 25 is not able to detect a normal speed, the movement speed computation unit 36 employs the second movement speed. When the first movement speed and the second movement speed are normal, the movement speed computation unit 36 employs a movement speed that is assumed to be more correct from the speed data measured until then. In this manner, the movement speed computation unit 36 determines a movement speed of the mobile terminal 2 based on at least one of the first movement speed and the second movement speed.

According to this configuration, even when a state in which radio waves transmitted from the positioning satellite 3 are received is poor, the first movement speed can be detected by the acceleration sensor 25. When a state in which radio waves transmitted from the positioning satellite 3 are received is good, the second movement speed can be detected. By combining the first movement speed and the second movement speed, the movement speed computation unit 36 can recognize the position with high accuracy.

In addition, the CPU 11 includes a communication interval determination unit 37. The communication interval determination unit 37 of the control unit 9 determines a communication interval at which the communication unit 15 communicates based on the movement speed of the mobile terminal 2. The communication interval determination unit 37 determines a communication interval such that the communication interval is longer when the movement speed is lower. The communication interval determination unit 37 determines a communication interval such that the communication interval is shorter when the movement speed becomes higher. The communication unit 15 communicates at the communication interval determined by the communication interval determination unit 37. The communication interval setting unit 35 performs an initial setting of the communication interval. The communication interval determination unit 37 changes the communication interval with reference to the speed of the mobile terminal 2.

According to this configuration, a communication interval is determined so that the communication interval becomes longer when a movement speed is low. A communication interval is determined such that the communication interval is shorter when the movement speed becomes higher. The distance in which the mobile terminal 2 moves within the time of the communication interval is calculated by multiplying the movement speed by the communication interval. Thus, even if the movement speed changes, the distance in which the mobile terminal 2 moves within the time of the communication interval is not likely to change. As a result, the position information can be transmitted at intervals of an appropriate distance even when the movement speed is changed.

The movement speed computation unit 36 of the control unit 9 may determine a movement speed based on a statistical value of a plurality of values of the movement speed detected in a predetermined period. Then, the communication interval determination unit 37 may determine the communication interval using the movement speed determined based on the statistical value.

Although the predetermined period in which the movement speed is detected is not particularly limited, it is 10 seconds in this embodiment, for example. Because a movement speed is detected every second, statistical processing is performed using data of 10 movement speeds. The mean, mode, median, and maximum may be used for the statistical processing of the movement speeds.

According to this configuration, a communication interval is determined from the statistical processing. Thus, a detection error in movement speeds can be reduced.

In addition, the CPU 11 includes a communication interval computation unit 38. The communication interval computation unit 38 calculates a calculation result by dividing a movement interval set value 28 stored in the memory 12 by a movement speed. The communication interval determination unit 37 determines the calculation result as a communication interval.

According to this configuration, the position information can be transmitted each time the mobile terminal moves the distance indicated by the movement interval set value 28. Therefore, the position of the player carrying the mobile terminal 2 can be accurately grasped. As a result, it makes easier to make a response such as rescue or assistance, search, and the like.

In addition, the CPU 11 has a sport type detection unit 39. The sport type detection unit 39 inputs a movement speed of the mobile terminal 2 from the speed conversion unit 16. The sport type detection unit 39 inputs an angular velocity of the mobile terminal 2 from the gyro sensor 17. The sport type detection unit 39 compares the movement speed and the angular velocity of the mobile terminal 2 with the sport type determination data 31 to detect the type of the game played by the player.

In addition, the CPU 11 has an input control unit 40. The input control unit 40 controls the input device 18. In other words, the input control unit 40 outputs an instruction signal to the communication unit 15, and inputs the type of sport performed in the game from the application server 6. In addition, the CPU 11 has a display control unit 41. The display control unit 41 controls the content to be displayed on the display device 19. In addition, the CPU 11 has an integrated control unit 42. The integrated control unit 42 controls the order performed by each of the function implementation units.

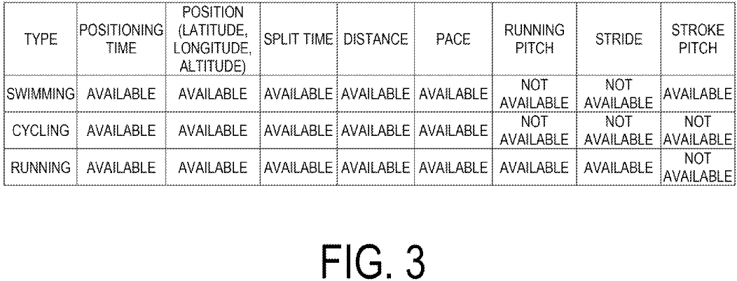

The measurement data 34 includes various types of data as illustrated in FIG. 3. A positioning time indicates a time at which the position to be transmitted is detected. A split time indicates a time that has elapsed from a predetermined time. A distance indicates a distance in which a terminal moved from a predetermined position. A pace indicates a movement speed. A running pitch indicates the number of times that the feet are grounded per minute while running. A stride indicates a distance per step. A stroke pitch in swimming indicates the number of times that the arms rotate for one minute. Data of the items marked as “present” in the various types is acquired.

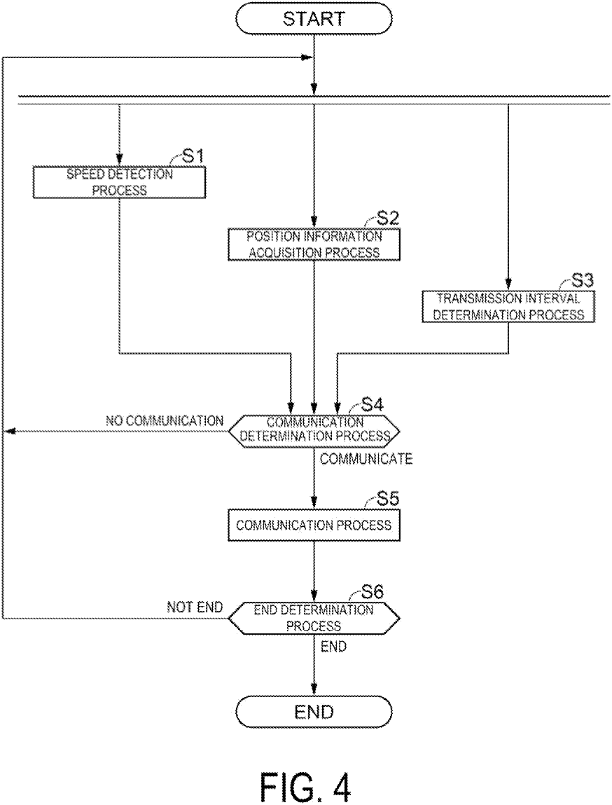

Next, a control method of the above-described mobile terminal 2 will be described. In the flowchart of FIG. 4, step S1, step S2, and step S3 are performed in parallel. Step S1 corresponds to a speed detection process. The movement speed detection unit 14 detects the second movement speed as a movement speed of the mobile terminal 2. Furthermore, the acceleration sensor 25 and the speed conversion unit 16 may detect the first movement speed as the movement speed of the mobile terminal 2. The movement speed computation unit 36 determines the movement speed from the first movement speed and the second movement speed. Next, the process proceeds to step S4.

Step S2 is a position information acquisition process. This process is a process of the position information acquisition unit 13 to acquire position information at predetermined intervals. Although the predetermined interval is not particularly limited, in this embodiment, for example, it is 1 second. Next, the process proceeds to step S4.

Step S3 is a transmission interval determination process. In this process, the movement speed computation unit 36 determines the movement speed based on a statistical value of a plurality of values of the movement speed detected for a predetermined period. Next, the communication interval determination unit 37 of the control unit 9 determines a communication interval such that the communication interval is longer when the movement speed is lower. The communication interval determination unit 37 of the control unit 9 determines a communication interval such that the communication interval is shorter when the movement speed becomes higher. Next, the process proceeds to step S4.

Step S4 is a communication determination process. This process is a process of determining whether it is time to communicate. The integrated control unit 42 of the control unit 9 determines whether the time that elapsed after the communication unit 15 communicated with the first base station 4 exceeds a set value of a communication interval. The integrated control unit 42 determines that no communication is performed if the time elapsed after the communication unit 15 communicated with the first base station 4 does not exceed the set value of the communication interval. Then, the process transitions to step S1, step S2, and step S3. The integrated control unit 42 determines that communication is being performed if the time elapsed after the communication unit 15 communicated with the first base station 4 exceeds the set value of the communication interval. Next, the process proceeds to step S5.

Step S5 is a communication process. This process is a process in which the communication unit 15 communicates with the application server 6 via the first base station 4 and the system server 5, and transmits the measurement data 34 including the positional information. In step S4 and step S5, the communication unit 15 communicates at a communication interval determined by the communication interval determination unit 37 of the control unit 9. Next, the process transitions to step S6.

Step S6 is an end determination process. This process is a process of the integrated control unit 42 to determine whether to end the process of communication of the measurement data 34 performed for each set value of the communication interval. When a player does not input an instruction to end from the input device 18, the integrated control unit 42 determines not to end the above-described process. Next, the process transitions to step S1, step S2, and step S3. When a player inputs an instruction to end from the input device 18, the integrated control unit 42 determines to end the above-described process. Then, the control of steps S1 to S6 ends.

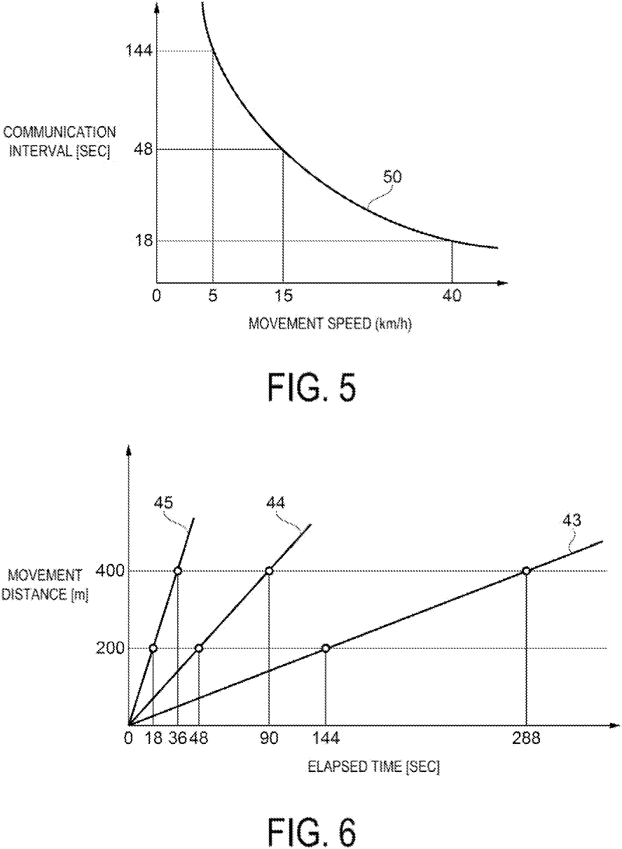

FIG. 5 corresponds to the transmission interval determination process of step S3. The horizontal axis of FIG. 5 indicates movement speed of the mobile terminal 2. The vertical axis indicates communication interval. A first speed communication interval relationship line 50 indicates a communication interval computed by the communication interval computation unit 38 when the movement interval set value 28 is 200 meters. When the movement speed is set to X km/h and the communication interval is set to Y seconds, the first speed communication interval relationship line 50 indicates a formula Y = 200 X 3.6/X. “3.6” is a unit conversion factor. When the type of game is swimming, the average speed of a player is approximately 5 km/h. When a movement speed of the mobile terminal 2 is 5 km/h, the communication interval computation unit 38 inputs 200 meters and 5 km/h into the above-described division formula to compute 144 seconds. Then, the communication interval determination unit 37 determines the movement interval set value 28 to 144 seconds.

When the type of game is running, the average speed of a player is approximately 15 km/h. When a movement speed of the mobile terminal 2 is 15 km/h, the communication interval computation unit 38 inputs 200 meters and 15 km/h into the above-described division formula to compute 48 seconds. Then, the communication interval determination unit 37 determines the movement interval set value 28 to 48 seconds.

When the type of game is cycling, the average speed of a player is approximately 40 km/h. When a movement speed of the mobile terminal 2 is 40 km/h, the communication interval computation unit 38 divides 200 meters by 40 km/h to compute 18 seconds. Then, the communication interval determination unit 37 determines the movement interval set value 28 to 18 seconds.

FIG. 6 is a diagram corresponding to the communication determination process of step S4 and the communication process of step S5. The horizontal axis in FIG. 6 indicates the elapsed time. The vertical axis indicates movement distance of the mobile terminal 2 and a player. A first speed line 43 indicates a relationship between the elapsed time and the movement distance when the movement speed of the mobile terminal 2 is 5 km/h. The first speed line 43 indicates the state in which the type of game is swimming. The round marks indicate the points at which the communication unit 15 communicates. When the movement speed of the mobile terminal 2 is 5 km/h, communication is performed every 144 seconds. The movement distance in which the mobile terminal 2 and the player move at the communication intervals is 200 meters.

A second speed line 44 indicates a relationship between the elapsed time and the movement distance when the movement speed of the mobile terminal 2 is 15 km/h. The second speed line 44 is a state in which the type of game is running. When the movement speed of the mobile terminal 2 is 15 km/h, communication is performed every 48 seconds. The movement distance in which the mobile terminal 2 and the player move at the communication intervals is 200 meters.

A third speed line 45 indicates a relationship between the elapsed time and the movement distance when the movement speed of the mobile terminal 2 is 40 km/h. The third speed line 45 is a state in which the type of game is cycling. When the movement speed of the mobile terminal 2 is 40 km/h, communication is performed every 18 seconds. The movement distance in which the mobile terminal 2 and the player move at the communication intervals is 200 meters. In this way, the movement distance in which the mobile terminal 2 and the player move at the communication intervals in each type of game is 200 meters. The communication unit 15 communicates each time the player moves 200 meters in each of the games including swimming, running, and cycling.

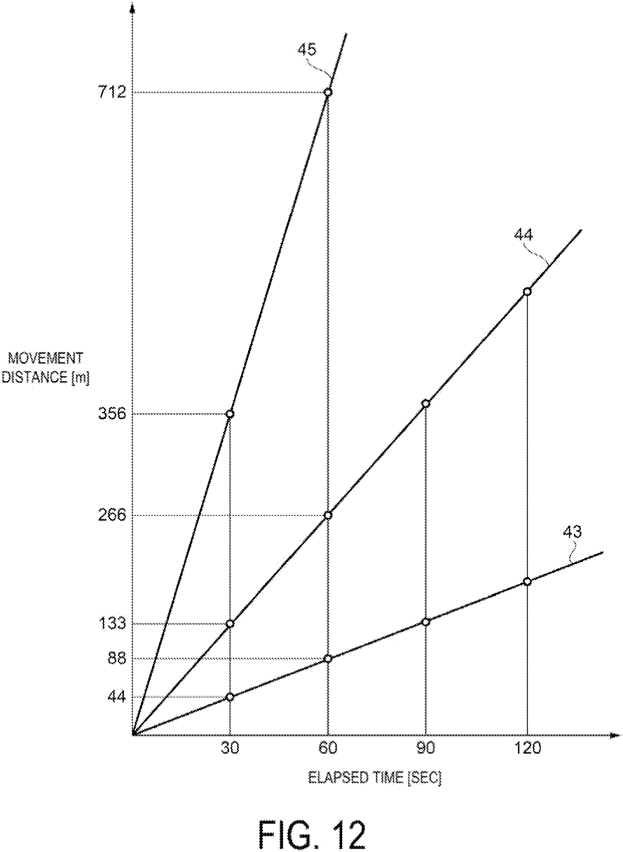

FIG. 12 illustrates a relationship between the elapsed time and the movement distance of the mobile terminal 2 in a comparative example. The communication interval is 30 seconds in the type of each game. Communication is performed every 44 meters when the first speed line 43 indicates swimming. Communication is performed every 133 meters when the second speed line 44 indicates running. The communication is performed every 356 meters when the third speed line 45 indicates cycling. In this way, the movement distance in which the mobile terminal 2 and the player move at the communication intervals differs in each type of game.

According to the method of this embodiment, a communication interval is determined such that the communication interval is longer when the movement speed is lower. A communication interval is determined such that the communication interval is shorter when the movement speed becomes higher. The distance in which the mobile terminal 2 moves within the time of the communication interval is calculated by multiplying the movement speed by the communication interval. Thus, even if the movement speed changes, the distance in which the mobile terminal 2 moves within the time of the communication interval is not likely to change. As a result, the position information can be transmitted at intervals of an appropriate distance even when the movement speed is changed.

A communication frequency can be reduced compared to the comparative example. Accordingly, the power consumption of the battery contained in the mobile terminal 2 can be reduced. As a result, the battery life can be increased.

### Second Embodiment

This embodiment differs from the first embodiment in that the method of determining a communication interval is different. Further, configurations identical to those in the first embodiment will be denoted by the same reference signs and redundant descriptions will be omitted.

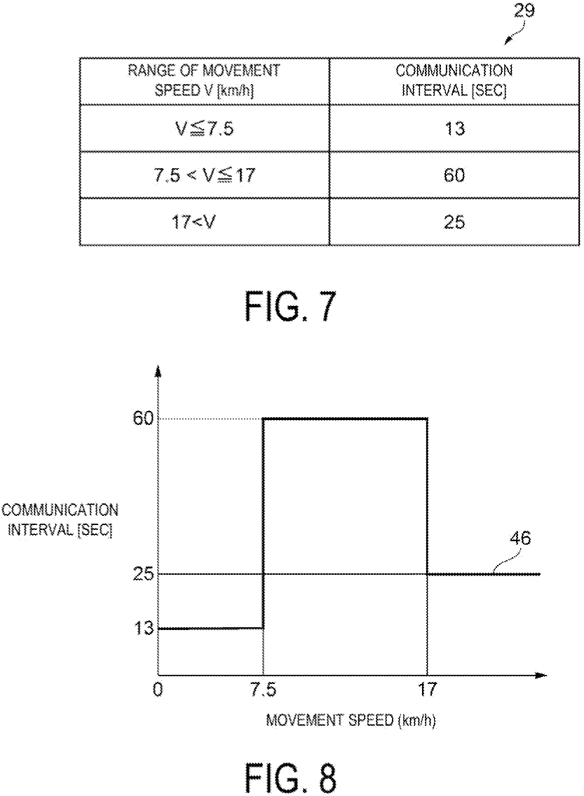

The movement speed determination table 29 indicating communication intervals corresponding to movement speeds of the mobile terminal 2 and the player is stored in the memory 12 as illustrated in FIG. 7. In other words, the memory 12 stores the movement speed determination table 29 indicating the relationship between the determined values of the movement speeds and the communication intervals. The communication interval determination unit 37 of the control unit 9 compares the movement speeds of the mobile terminal 2 and the player with the determined values of the movement speeds to determine the communication intervals.

FIG. 8 illustrates a relationship between the movement speeds and communication intervals of the mobile terminal 2 in the movement speed determination table 29. The horizontal axis indicates movement speed. The vertical axis indicates communication interval. A second speed communication interval relationship line 46 represents the relationship between the movement speeds and the communication intervals indicated by the movement speed determination table 29. The range of movement speed from 0 to 7.5 km/h is applied when the type of game is swimming. At this time, the communication interval is 13 seconds, and is shorter than that of other games. In this range of movement speed, the player moves approximately 20 meters between the communication intervals.

The range of movement speed from 7.5 to 17 km/h is applied when the type of game is running. At this time, the communication interval is 60 seconds. In this range of movement speed, the player moves approximately 258 meters between the communication intervals. The range of movement speed equal to or higher than 17 km/h is applied when the type of game is cycling. At this time, the communication interval is 25 seconds. In this range of movement speed, the player moves approximately 300 meters between the communication intervals.

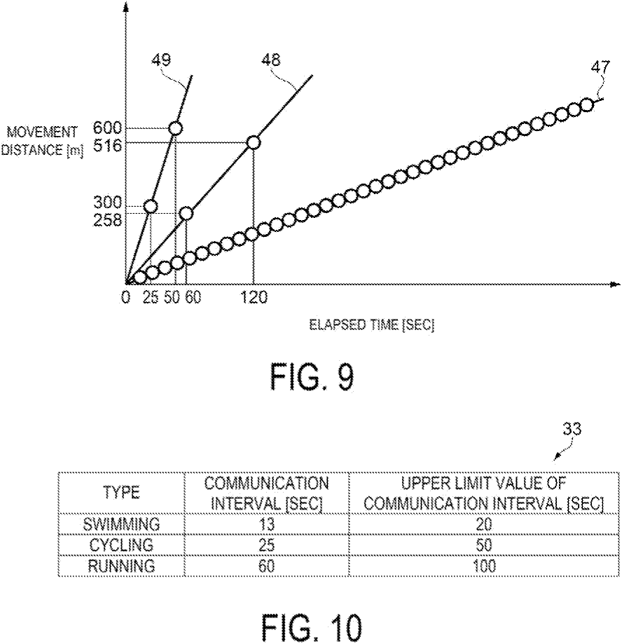

FIG. 9 is a diagram corresponding to the communication determination process of step S4 and the communication process of step S5. The horizontal axis of FIG. 9 indicates the elapsed time in which the communication unit 15 communicates. The vertical axis indicates movement distance of the mobile terminal 2 and the player. A fourth speed line 47 indicates a relationship between the elapsed time and the movement distance when the movement speed of the mobile terminal 2 is 5 km/h. The fourth speed line 47 is applied when the type of game is swimming. The circular marks indicate the points at which the communication unit 15 communicates. When the movement speed of the mobile terminal 2 is 7.5 km/h or lower, communication is performed every 13 seconds. The movement distance in which the mobile terminal 2 and the player move at the communication intervals is 20 meters. When the player has a problem during the swimming game, a life saver heads for rescue. At this time, the position of the player can be found within an error range of 20 meters.

A fifth speed line 48 indicates a relationship between the elapsed time and the movement distance when the movement speed of the mobile terminal 2 is 7.5 km/h or higher and lower than 17 km/h. The fifth speed line 48 is applied when the type of game is running. When the movement speed of the mobile terminal 2 is 7.5 km/h or higher and lower than 17 km/h, communication is performed every 60 seconds. When the movement speed of the mobile terminal 2 is approximately 15 km/h, the movement distance in which the mobile terminal 2 and the player move at the communication intervals is approximately 258 meters.

A sixth speed line 49 indicates the relationship between the elapsed time and the movement distance when the movement speed of the mobile terminal 2 exceeds 17 km/h. The sixth speed line 49 is applied when the type of game is cycling. When the movement speed of the mobile terminal 2 exceeds 17 km/h, communication is performed every 25 seconds. When the movement speed of the mobile terminal 2 is approximately 40 km/h, the movement distance in which the mobile terminal 2 and the player move at the communication intervals is approximately 300 meters. In this way, the movement distance in which the mobile terminal 2 and the player move at the communication intervals when the types of games are running and cycling is 258 to 300 meters.

According to this configuration, it is possible to set an appropriate communication interval according to the state of the person carrying the mobile terminal 2. An appropriate communication interval can be set by setting the movement speed determination table 29 according to the type of game.

### Third Embodiment

This embodiment differs from the first embodiment in that the method of determining a communication interval is different. Further, configurations identical to those in the first embodiment will be denoted by the same reference signs and redundant descriptions will be omitted.

The sport type detection unit 39 of the control unit 9 inputs a movement speed of the mobile terminal 2 from the speed conversion unit 16. The sport type detection unit 39 inputs an angular velocity of the mobile terminal 2 from the gyro sensor 17.

The player wears the mobile terminal 2 around his or her arm. Because the player moves his or her arm a lot while swimming, the angular velocity of the mobile terminal 2 is changed greatly. The movement speed of the player is slower than that in running and cycling. Because the player moves his or her arm in the range of a predetermined angle while running, the angular velocity of the mobile terminal 2 is changed less than that in swimming. Because the player rarely moves his or her arm while cycling, the angular velocity of the mobile terminal 2 is changed less than that in running. The mobile terminal 2 has characteristic angular velocities according to the types of games as described above. Thus, the sport type detection unit 39 can infer the type of game from an angular velocity and a movement speed of the mobile terminal 2. Furthermore, a detailed case is introduced in JP-A-2015-109946.

The sport type detection unit 39 of the control unit 9 determines the type of sport performed by the player based on the movement speed and the angular velocity of the mobile terminal 2.

The sport type-communication interval correspondence table 33 shows the correspondence relationship between the types of sports and the communication intervals as illustrated in FIG. 10. The sport type-communication interval correspondence table 33 is stored in the memory 12. The communication interval determination unit 37 of the control unit 9 determines a communication interval based on the type of sport and the sport type-communication interval correspondence table 33.

According to this configuration, the speed conversion unit 16, the acceleration sensor 25, the gyro sensor 17, and the sport type detection unit 39 of the control unit 9 determine the type of sport. Thus, even when a person carrying the mobile terminal 2 changes the type of sport, the position information can be communicated at appropriate communication intervals suitable for details of the sport, without performing an operation such as input of the type of sport.

### Fourth Embodiment

This embodiment differs from the first embodiment in that the method of determining a communication interval is different and an upper limit value of the communication interval is set. Further, configurations identical to those in the first embodiment will be denoted by the same reference signs and redundant descriptions will be omitted.

The input device 18 receives an input of the type of sport by the player. For example, the letters “swimming”, “cycling”, or “running” are displayed on the display device 19, and the player operates a button to select any one of “swimming”, “cycling”, and “running”. The sport type-communication interval correspondence table 33 shows the correspondence relationship between the types of sports and the communication intervals as illustrated in FIG. 10. The communication interval determination unit 37 of the control unit 9 determines a communication interval to be equal to or lower than the upper limit value of the communication intervals. For example, the upper limit value of the communication interval of swimming is set to 20 seconds. When the player selects “swimming” for the type of game, the communication unit 15 performs communication for the measurement data 34 at communication intervals of 20 seconds or shorter.

According to this configuration, because a communication interval is set to be equal to or shorter than the upper limit value, the position accuracy of the person carrying the mobile terminal 2 can be set to be equal to or lower than the calculation value obtained by multiplying the upper limit value of the communication interval by the movement speed of the player. As a result, it makes easier to make a response such as rescue or assistance, search, and the like.

### Fifth Embodiment

This embodiment differs from the first embodiment in that the method of determining a communication interval is different. Further, configurations identical to those in the first embodiment will be denoted by the same reference signs and redundant descriptions will be omitted.

The input device 18 receives an input of the type of sport by the player. The sport type-communication interval correspondence table 33 shows the correspondence relationship between the types of sports and the communication intervals as illustrated in FIG. 10. The communication interval determination unit 37 of the control unit 9 determines a communication interval based on the type of sport and the sport type-communication interval correspondence table 33. The communication unit 15 performs communication at the communication intervals determined by the communication interval determination unit 37 of the control unit 9.

According to this configuration, position information can be communicated at the communication intervals suitable for the type of sport.

### Sixth Embodiment

This embodiment differs from the fifth embodiment in that a method of inputting the type of sport is different. Further, configurations identical to those in the fifth embodiment will be denoted by the same reference signs and redundant descriptions will be omitted.

In this embodiment, the communication unit 15 communicates with the application server 6 via the first base station 4 and the system server 5. The communication unit 15 receives an input of the sport type data 32 from the application server 6.

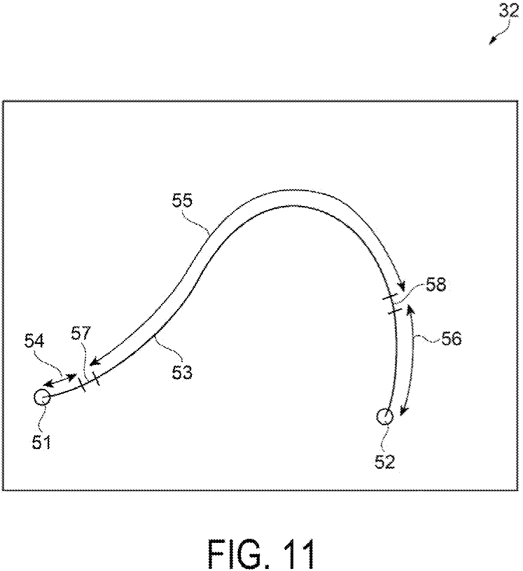

The sport type data 32 includes a start point 51 at which the player starts a game as illustrated in FIG. 11. In addition, the sport type data 32 includes a finish point 52 at which the player finishes the game. In addition, the sport type data 32 includes a route 53 from a start point 51 to a finish point 52.

In addition, the sport type data 32 includes a swimming section 54 in which the player swims, a cycling section 55 in which the player performs cycling, and a running section 56 in which the player runs. In addition, the sport type data 32 includes a first transition area 57 between the swimming section 54 and the cycling section 55, and a second transition area 58 between the cycling section 55 and the running section 56. The player moves in the order of the start point 51, the swimming section 54, the first transition area 57, the cycling section 55, the second transition area 58, the running section 56, and the finish point 52.

The sport type data 32 includes information of the latitude and longitude of each location along a route 53. The sport type detection unit 39 of the control unit 9 recognizes the type of game corresponding to information of the current location detected by the position information acquisition unit 13 and the location where the player is currently present from the sport type data 32 and the type of sport expected to be performed next.

The sport type detection unit 39 recognizes at the start point 51 that the type of game to be played by the player is swimming. The communication interval determination unit 37 receives an input of information of the type of game from the sport type detection unit 39. The communication interval determination unit 37 sets the communication interval to 13 seconds with reference to the sport type-communication interval correspondence table 33 illustrated in FIG. 10. The communication interval is maintained at 13 seconds in the swimming section 54.

The sport type detection unit 39 recognizes in the first transition area 57 that the type of game to be played next by the player is cycling. The communication interval determination unit 37 receives an input of information of the type of game from the sport type detection unit 39. The communication interval determination unit 37 sets the communication interval to 25 seconds with reference to the sport type-communication interval correspondence table 33. The communication interval is maintained at 25 seconds in the cycling section 55.

The sport type detection unit 39 recognizes in the second transition area 58 that the type of game to be played next by the player is running. The communication interval determination unit 37 receives an input of information of the type of game from the sport type detection unit 39. The communication interval determination unit 37 sets the communication interval to 60 seconds with reference to the sport type-communication interval correspondence table 33. The communication interval is maintained at 60 seconds in the running section 56.

The sport type detection unit 39 recognizes at the finish point 52 that the game has finished. The communication interval determination unit 37 receives an input of the information of the type of game from the sport type detection unit 39. The communication interval determination unit 37 determines to end the communication after communication is performed for a predetermined period. A value of the “predetermined period” is settable, and for example, the value is 30 seconds in this embodiment.

In the mobile terminal 2 of this embodiment, the position information acquisition unit 13 acquires position information as described above. The communication unit 15 communicates with the first base station 4 to acquire position information. The communication unit 15 receives an input of the type of sport. The memory 12 stores the sport type-communication interval correspondence table 33. The communication interval determination unit 37 of the control unit 9 determines a communication interval based on the type of sport and the sport type-communication interval correspondence table 33. The communication unit 15 communicates at the communication interval determined by the communication interval determination unit 37.

According to this configuration, the position information can be communicated at the communication intervals suitable for the type of sport.

### Seventh Embodiment

The type of game is determined based on the sport type data 32 in the sixth embodiment. In addition, a player may operate the input device 18 such as a button to specify the type of sport. At this time, position information can be communicated at the communication interval appropriate for the type of sport.

### Eighth Embodiment

The mobile terminal 2 is used in a triathlon game in the first embodiment to the sixth embodiment. In addition, the mobile terminal 2 may be used in a marathon game or trail running. In addition, the mobile terminal 2 may be used for running, cycling, and swimming in personal training. In addition, the mobile terminal 2 may be used for sport involved with movement such as tracking.

### Ninth Embodiment

The communication unit 15 in the first embodiment may perform communication using Bluetooth (a registered trademark). For example, communication by Bluetooth (a registered trademark) may be used for the participation procedure of a game.

What is claimed is:

1. A mobile terminal comprising:
a position information acquisition unit configured to receive radio waves transmitted from a positioning satellite and process the radio waves to acquire position information;
a movement speed detection unit configured to use the Doppler effect of the radio waves transmitted from the positioning satellite to detect a movement speed;
a communication unit configured to communicate with a base station for the position information using wireless communication; and
a control unit configured to determine a communication interval at which the communication unit performs communication based on the movement speed, wherein
the control unit determines the communication interval such that the communication interval is longer when the movement speed is lower, and
the communication unit performs communication at the communication interval determined by the control unit.

2. The mobile terminal according to claim 1, wherein the control unit determines the communication interval based on a statistical value of a plurality of values of the movement speed detected in a predetermined period.

3. The mobile terminal according to claim 1, comprising:
a storage unit configured to store a movement interval set value corresponding to the communication interval, wherein
the control unit determines the communication interval by dividing the movement interval set value by the movement speed.

4. The mobile terminal according to claim 1, comprising:
a storage unit configured to store a movement speed determination table showing a relationship between a determined value of the movement speed and the communication interval, wherein
the control unit determines the communication interval by comparing the movement speed with the determined value of the movement speed.

5. The mobile terminal according to claim 1, comprising:
a gyro sensor configured to detect an angular velocity, wherein
the control unit determines a type of sport based on the movement speed and the angular velocity, includes a storage unit configured to store a sport type-communication interval correspondence table indicating a correspondence relationship between the type of sport and the communication interval, and determines the communication interval based on the type of sport and the sport type-communication interval correspondence table.

6. The mobile terminal according to claim 1, wherein
the movement speed detection unit includes an acceleration sensor, and
the control unit determines the movement speed based on at least one of a first movement speed detected by the acceleration sensor and a second movement speed detected by using the Doppler effect of the radio waves transmitted from the positioning satellite.

7. The mobile terminal according to claim 1, comprising:
an input unit configured to input a type of sport; and
a storage unit configured to store a sport type-communication interval correspondence table indicating a correspondence relationship between the type of sport and an upper limit value of the communication interval, wherein
the control unit determines the communication interval to be lower than or equal to the upper limit value of the communication interval.

8. A mobile terminal comprising:
a position information acquisition unit configured to receive radio waves transmitted from a positioning satellite and process the radio waves to acquire position information;
a communication unit configured to communicate with a base station for the position information using wireless communication;
an input unit configured to input a type of sport;
a storage unit configured to store a sport type-communication interval correspondence table indicating a correspondence relationship between the type of sport and a communication interval at which the communication unit performs communication; and
a control unit configured to determine the communication interval based on the type of sport and the sport type-communication interval correspondence table, wherein
the communication unit performs communication at the communication interval determined by the control unit.

9. A control method for a mobile terminal including
a position information acquisition unit configured to receive radio waves transmitted from a positioning satellite and process the radio waves to acquire position information, a movement speed detection unit configured to use the Doppler effect of the radio waves transmitted from the positioning satellite to detect a movement speed, a communication unit configured to communicate with a base station for the position information using wireless communication, and a control unit configured to determine a communication interval at which the communication unit performs communication, the control method comprising:
acquiring, by the position information acquisition unit, the position information at a predetermined interval;
detecting, by the movement speed detection unit, the movement speed;
determining, by the control unit, the communication interval such that the communication interval is longer when the movement speed is lower; and
performing communication, by the communication unit, at the communication interval determined by the control unit.
